(19) United States
(12) Patent Application Publication
(10) Pub. No.: US 2002/0174187 A1
(43) Pub. Date: Nov. 21, 2002

(54) Internet access and control of video storage and retrieval systems

(76) Inventors: Charles P. Kollar, Pittsburgh, PA (US); Derek Minno, Wexford, PA (US); Richard Roberts, Sewickley, PA (US); Steven Gold, Pittsburgh, PA (US); Tim Megela, Pittsburgh, PA (US)

Correspondence Address: Cohen & Grigsby, P.C., 15th Floor, 11 Stanwix Street, Pittsburgh, PA, 15222, US

(21) Appl. No.: 09/862,113

(22) Filed: May 21, 2001

(51) Int. Cl. G06F 15/16

(52) U.S. Cl. 709/208; 709/203; 725/100; 725/151

(57) ABSTRACT

The present invention relates to a system for the remote control of a system for storage and retrieval of data/audio/visual signals by using a link on a web page. The link addresses a control server though an internet portal or web site. The control server communicates with a control processor associated with a digital set top box. The control processor is responsible for the storage and retrieval of the data/audio/video on the set top box. The web page containing the web page and link having access to the system is included in a network (internet) that receives input from a user of the system.

### FIELD OF THE INVENTION

The present invention relates to apparatus and methods for accessing a system for storing and retrieving data from a network and, more specifically, to apparatus and methods for accessing such systems from an internet web page and for synchronizing modifications to a processor that is used to control recording and retrieval of data, video and audio signals by a network, and making the synchronized information available on an internet web page.

### BACKGROUND OF THE INVENTION

It is well known to store and retrieve audio and video signals from broadcasts and cable transmissions. Typical storage media includes analog records such as a video tape recorder or digital recordings such as hard drives, CD discs, or DVD disks. Digital signals also include data, video and audio transmitted over private networks. The signals that are stored can be made at the user's location or at a broadcast or at locations broadcasters or re-broadcasters or those providing secondary transmissions.

In general, the systems used for storing broadcast or primary transmissions are single program devices that record and store one program at a time and play back one program at a time. Recently, devices have been introduced that have the ability to record multiple programs simultaneously and permit simultaneous playback. In some cases, digital storage has been used to store digitized video and audio signals as well as digitized analog video and audio signals. Typically the storage medium is a hard disk drive in a computer or other processor/control means associated with a set top box or located at the cable operators head end.

However, there was still a need in the prior art for a system and method for remotely commanding the storing of data/audio/video signals, and in remotely viewing the information about what data/audio/video signals have been recorded and what unfulfilled recording commands have been issued. In particular, there was a need for a system and method by which the user could command such storage from a location that was physically remote form other portions of the system where the data/audio/video signals were either stored or were produced as audible sounds or visual images. Accordingly, it is an object of the presently disclosed invention to provide a system and method by which the storage of data/audio/video signals can be accomplished or modified by commands to the system from remote locations.

Other objectives and advantages of the present invention will become apparent to those who are normally skilled in the art as the description of a preferred embodiment of the invention proceeds.

### SUMMARY OF THE INVENTION

In accordance with the presently disclosed invention, a system for the storage and retrieval of data/audio/video signals includes a control processor in communication with a first network that allows the delivery of data/audio/video signals to, and optionally from, the control processor. The control processor allow a user to control aspects of, though not limited to, the recording and playback of data/audio/video signals broadcast on the first network both at the time of broadcast and at a time after broadcast through the recording of the data/audio/video signals on storage located either in the network or near the control processor, through the set top box (STB). A control server communicates with the control processor through either the first network, or optionally a second network, for the purposes of maintaining a virtual representation of, though not limited to, the data/audio/video signals recorded on the control processor, and optionally the ability to command the control processor to effect the storage of data/audio/video signals that the user selects through the control server. The control server gives the user the ability to view the virtual representation of the control processor and to command the control processor to effect the storage of data/audio/video signals in response to user commands such as a mouse click or other user command through one of more web pages that the control sever creates for display to the user. Links associated with the web pages that the control server creates are imbedded in the web pages associated with one or more web sites or portals and are accessed through the internet or other networks via web browsers on personal computer or other devices capable of rendering web pages such as, but not limited to, telephones, or personal digital assistants.

Preferably, the link is of the type that views the virtual representation of the control processor or of the type that modifies the operation of the control processor. Also preferably, the control server is responsive to login information form the link.

More preferably, the modifications to the virtual representation of the control processor and the modification to the actual control processor are synchronized so that the virtual representation matches the actual configuration of the control processor in the shortest time period as possible.

Other advantages of the present invention will become apparent from a perusal of the following detailed description of a presently preferred embodiment of the invention taken in connection with the accompanying drawing.

### BRIEF DESCRIPTION OF THE DRAWINGS

FIG. 1 is a diagram that further illustrates the system wherein the Control Processor is accessed from a web page and the system synchronizes changes to the user's set top box;

FIG. 2 illustrates further details of the system illustrated in FIG. 1; and

FIG. 3 is a diagram that further illustrates the system of FIG. 1 wherein the system is accessed form a web page.

### PRESENTLY PREFERRED EMBODIMENT

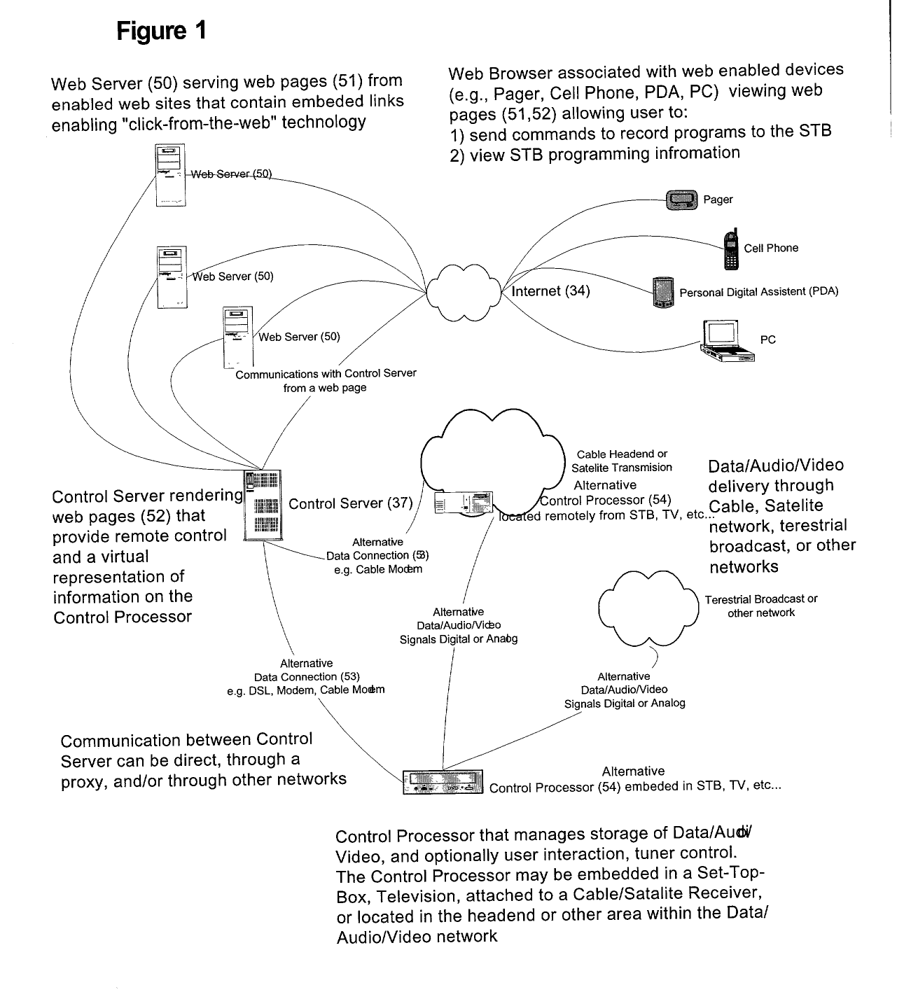

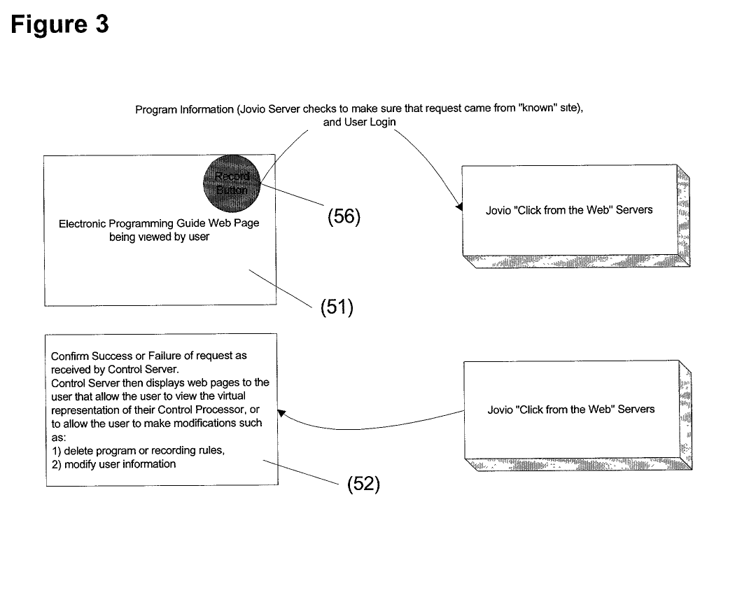

The system that is herein disclosed affords programming of a user's set top box from websites that are located in a network 34. As more specifically described in connection with FIG. 1, the system incorporates “click-from-the-web” technology (as more specifically described herein) to allow a registered user to program the control processor 54 associated with their set top box remotely from any enabled website. As further shown and described in FIG. 1, the system includes web servers 50, control server 37, and the control processor 54. As further shown and described in FIG. 3, a web server displays web pages 51 that includes links 56 that identify web pages 52 derived from the control server. Links 56 can be placed on any web page created by the web server 50 to give the associated web page capability for programming set top boxes. Typically, the web pages that are selected are pages of the type that are associated with electronic programming guides.

Links 56 can be of various types. For example, one type of link 56 allows the user to view a virtual incarnation of the control processor 54 associated with a set top box (i.e. the control processor as configured in accordance with the most recent synchronization between the users control processor 54 and control server 37). Another type of link 56 allows the user to add a rule to their control processor 54 that will cause the set top box to record selected programs.

Control server 37 is responsive to commands from links 56 only from web sites 50 that are “known” to the control server 37. That is, control server 37 must be able to recognize the web site 50 as being a legitimate web site from which the commands are authorized. In addition, control server 37 must also receive the correct “log in” information from the web site link. To accomplish this verification, control server 37 check the “referrer” information that is associated with the link. That is, control server 37 checks the web site to determine if it has been pre-established as an authentic web site. In addition, control server 37 will present the user with a user login web page requesting user login information. Control server 37 also places a “cookie” (if possible) in the user's browser so that the user does not have to log in again when they re-visit control server 37 from the same web site.

As stated above, control server 37 maintains a virtual representation of the user's control processor 54 that is typically controlled by the user directly through their set top box (STB). The user's control processor 54 is also synchronized with control server 37 such that changes to the user's control processor 54 are coordinated with changes that the user makes to their virtual control processor 54 on the web through web pages 52 generated by the control server 37. Changes form the user's control processor 54 or changes to the virtual control processor 54 are updated to control server 37. In this way, the virtual representation of the user's control processor remains current with the actual configuration of the user's control processor. The synchronization is accomplished through a data connection 53 between the control server and the control processor which can be through direct access in response to change commands that are introduced at the control processor or, alternatively, in a proxy server at the cable plant head end or network control. Synchronization between control server and control processor can be immediate or delayed in time as a result of the constraints placed on communication through the data connection 53. Communications between the control server and the control processor can optionally be encrypted using some form of encryption technology such as secure socket layer (SSL) in a TCP/IP environment. Accordingly, control server 37 provides a mechanism for the user to view their virtual control processor 54 through HTML links from a “web site that is known to control server 37.”

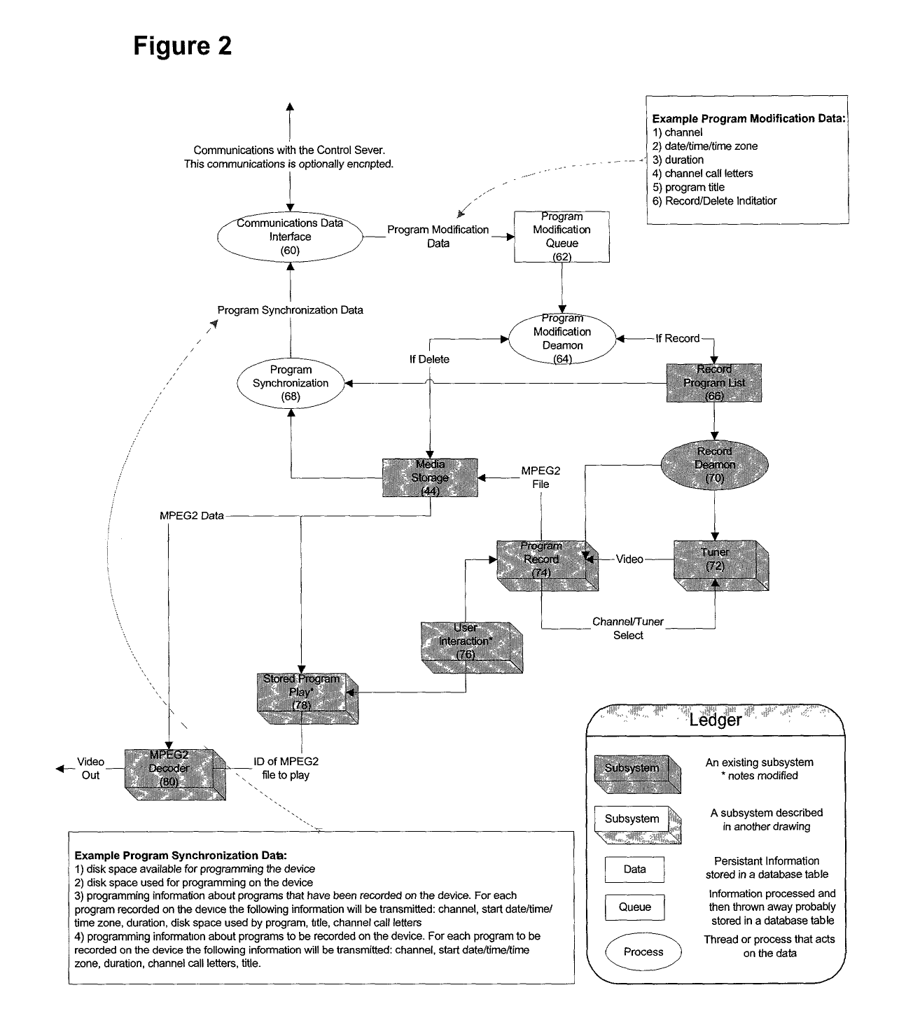

A presently preferred embodiment of the presently disclosed control processor 54 is further illustrated in FIG. 2 wherein information regarding changes that the user makes to their control processor from the web pages 52 are communicated from the control server 37 to the control processor through the data connection 53 to a communications data interface 60 process associated with the control processor which stores programming modification information in the program modification queue 62 of the control processor. For example, the program modification data would include information regarding:

Channel

Date/time/time zone

Duration

Channel call letters

Program title

Record/delete indicator

The program modification data located in the program modification queue 62 is assessed by the program modification deamon 64. If the modification data is to delete programming, the data is deleted from the media storage 44. If the modification data is to record programming or programming rules, a record command is transferred to a record program list 66.

The synchronization between the control server 37 and the control processor 54 are effected through the communications data interface 60 which will derive program synchronization information from the program synchronization 68 process. The program synchronization process will examine the record program list 66 and the media storage 44 and return information found there. For example, the types of data that will be returned would be as follows:

Disk space available for programming the device

Disk space used for programming on the device

Programming information about programs that have been recorded on the device. For each program recorded on the device the following information could also be transmitted: channel, start/data/time/time zone, duration, disk space used by program, title

Programming information about programs to be recorded on the device. For each program to be recorded on the device the following information could be transmitted: channel, start date/time/time zone, duration, title, channel call letters.

As further illustrated in FIG. 2, the record deamon 70 will examine the record program list and at the appropriate times instruct tuner 72 and program record 74 process to record the selected program and to store it in media storage 44. Thereafter, the user, through user interaction 76, instructs program record 74 to record a program or, stored program play 78, through MPEG2 decoder 80 to produce the appropriate video signal.

While a presently predefined embodiment of the invention has been shown or described in particularity, the invention may be otherwise embodied within the scope of the appended claims.

I claim:

1. A system for storage and retrieval of data/audio/video signals wherein a control processor affects the storage and retrieval of such data/audio/video signals; and said system further comprising;
a network of servers that communicate with the control server that in turn communicates with the control processor;
a plurality of web pages that are available through said network of servers, each of said web pages having at least one link that communicates with the control server in response to command signals to a link on said web pages.

2. The system of claim 1 wherein said control server contains a virtual representation of the user's control processor.

3. The system of claim 2 wherein said link provides a virtual representation of the user's control processor.

4. The system of claim 3 wherein said link enables the user to modify the operation of the control processor to cause the control processor to record data/audio/video signals during a time period that is selected by the user.

5. The system of claim 2 wherein the control server is responsive to the link only when the control server recognizes the web page on which the link is located.

6. The system of claim 5 wherein user login data is provided from the link to the control server, said control server being responsive to the link only when the control server recognizes the user login data.

7. The system of claim 2 wherein modifications to the control processor are synchronized with modifications to the virtual representation of the control processor that is stored in the control server.

8. A network that includes a plurality of servers, said network being connected to said control server, which is in turn connected to said control processor, said network providing signals to said control server in response to user actions, said network further including at least one web page on at least one server with said web page having a link that addresses the control server in response to user command signals to the link, said control server having a virtual representation of the control processor which is synchronized with said control processor, said control server being responsive to signals from said link to modify the virtual representation of the control processor in response to the link signals and then synchronizing these modifications with said control processor.

9. The system of claim 8 wherein said link is of the type by which the user modifies the virtual representation of the control processor.

10. The system of claim 8 wherein said link is of the type by which the user modifies the operation of the control processor.

11. The system of claim 8 wherein the signal from said link includes user login information.

12. The system of claim 8 wherein modification of the control processor and modification of the virtual representation of the control processor that is stored in the control server are synchronized.
